(19) United States
(12) Patent Application Publication
(10) Pub. No.: US 2015/0358751 A1
(43) Pub. Date: Dec. 10, 2015

(54) A Multifunctional Device For Assembly And Test Of Wire-Control Earphone

(71) Applicant: GOERTEK INC, Weifang City, Shandong (CN)

(72) Inventors: Shoubiao Deng, Weifang City, ShanDong Province (CN); Shuliang Gong, Weifang City, ShanDong Province (CN); Baohui Song, Weifang City, ShanDong Province (CN)

(73) Assignee: Goertek Inc., Weifang City, ShanDong Province (CN)

(21) Appl. No.: 14/761,722

(22) PCT Filed: Sep. 3, 2013
(86) PCT No.: PCT/CN2013/082836

§ 371 Date: Jul. 17, 2015

(30) Foreign Application Priority Data
Feb. 19, 2013 (CN) 201310053663.5

(51) Int. Cl. H04R 29/00

(52) U.S. Cl. CPC H04R 29/00

(57) ABSTRACT

The present invention discloses a multifunctional device for assembly and test of wire-control earphone, belonging to the technical field of assembly and test device of electronic products, comprising an operating platform, and a wire-control component region and a wire slot are provided on the upper surface of the operating platform, the assembly of wire-control component can be achieved by the operating platform; and touch control holes are provided in the wire-control component region, the touch control holes are in one-to-one correspondence with rods, each of the rods has a touch control end and an operating end, a socket is provided on the operating platform, the socket is connected to a circuit board, a test probe connection terminal is provided on the circuit board, and after an earphone plug is inserted into the socket, by pressing the operating end of the rod, the touch control terminal comes into contact with the contact point on the wire component, then through the test probe connection terminal on the circuit board, a signal is transmitted to an outer test device, thereby the test of the wire-control component is completed. The examples of the present invention can achieve the assembly and test of wire-control component, and achieve the universality of work device between different work stations, thus improve production efficiency greatly.

### TECHNICAL FIELD

The present invention relates to the technical field of assembly and test device for electronic products, in particular relates to a multifunctional device for the assembly and test of wire-control earphone.

### BACKGROUND ART

In recent years, with the escalation of human's consumption attitudes, many consumers want to operate the phone or the player mostly with the wire-control of earphone, which then raises a higher requirement to the design and production of wire-control earphone.

Currently, the production and test of wire-control earphone is moving towards an automatic and intelligent direction, and during the production process of wire-control earphone, the assembly and test of wire-control earphone should be completed at different work stations for installating wire-control components, testing wire-control component and so on, different devices are required to accommodate and test the earphone at different work stations, which is not only low in productivity, but also easy to damage the wire-control components of earphone, thus there is an urgent need for a multifunctional device capable of running through the entire production process.

### SUMMARY OF THE INVENTION

The technical problem to be solved by the present invention is to provide a multifunctional device for assembly and test of wire-control earphone, to solve the problem of low productivity due to the fact that the work device cannot be used in common between different work stations during the production process of wire-control earphone.

To solve the above problem, the technical solution of the present invention is a multifunctional device for assembly and test of wire-control earphone, comprising an operating platform, a wire-control component region for disposing a wire-control component and a wire slot for disposing an earphone wire are provided on the upper surface of the operating platform, several touch control holes corresponding to contact points on the wire-control component are provided in the wire-control component region of the operating platform, several rods are slidably mounted on the operating platform, the rods are in one-to-one correspondence with touch control holes, each of the rod has a touch control end corresponding to a touch control hole and an operating end protruding from the operating platform; a socket for connection to an earphone plug is provided on the operating platform, the socket is connected to a circuit board, a test probe connection terminals for connecting a test unit are provided on the circuit board.

As an improvement, the operating platform comprises a box body and an upper cover assembled fixedly as a whole, the wire-control component region, the wire slot and the touch control holes are provided on the upper cover, rod bushes are provided in the box body, the rod bushes and the box body are configured as a whole, the rods are slidably mounted in the rod bushes.

As a further improvement, an installation chamber for fixedly installing the socket and the circuit board is provided in the box body, an earphone plug connection channel for connecting the earphone plug to the socket is provided on the box body, a test probe connection hole is provided on the upper cover, the test probe connection hole corresponds to the position of the test probe connection terminal. As a further improvement, the test probe connection terminal is connected with a signal transmitting elastic sheet, the end of the signal transmitting elastic sheet is provided in the test probe connection hole.

As a further improvement, a rod cover for restricting the rods within the rod bushes is provided on the box body, the operating ends of the rods protrude from the rod cover, reset springs are provided between the touch control ends of the rods and the rod bushes.

As a further improvement, a container for accommodating earphone wire or other members is provided in the operating platform, the container is provided on one side of the wire-control component region.

As a further improvement, a wear-resistant bottom plate is provided at the bottom of the operating platform.

The above technical solution of the present invention can achieve the following beneficial effects: since the multifunctional device for assembly and test of wire-control earphone comprises an operating platform, and a wire-control component region and a wire slot are provided on the upper surface of the operating platform, the assembly of the wire-control component can be achieved by the operating platform; meanwhile, since touch control holes are provided in the wire-control component region, the touch control holes are in one-to-one correspondence with rods, each of the rods has a touch control end and an operating end, a socket is provided on the operating platform, the socket is connected to a circuit board, a test probe connection terminal is provided on the circuit board, after an earphone plug is inserted into the socket, by pressing the operating end of the rod, the touch control terminal comes into contact with the contact point on the wire component, then through the test probe connection terminal on the circuit board, a signal is transmitted to an outer test device, thereby the test of the wire-control component is completed; therefore, the multifunctional device for assembly and test of wire-control earphone can achieve the assembly and test of the wire-control component, and achieve the universality of work device between different work stations, thus improve production efficiency greatly.

Since the operating platform comprises a box body and an upper cover, the wire-control component region, the wire slot and the touch control holes are provided on the upper cover rod bushes are provided in the box body, the rod bushes and the box body are configured as a whole, and the rods are slidably mounted in the rod bushes, by configuring the operating platform as a replaceable structure, a corresponding upper cover can be replaced according to the type of earphone, thereby improving the universality of the operating platform.

Since the installation chamber and the earphone plug connection channel are provided in the box body, the test probe connection hole is provided on the upper cover, and the test probe connection hole correspond to the position of the test probe connection terminal, the socket and circuit board can be installed in the installation chamber in a compact structure, thereby saving the space greatly.

Since the test probe connection terminal is connected with the signal transmitting elastic sheet, and the end of the signal transmitting elastic sheet is provided in the test probe connection hole, a signal from the circuit board can be transmitted to the upper cover through the signal transmitting elastic sheet, and the probe of outer test device is only required to be connect to the test probe connection hole of the upper cover, which is convenient to operate.

Since the rod cover for restricting the rod within the rod bush is provided on the box body, the operating ends of the rods protrude from the rod cover, and reset springs are provided between the touch control ends of the rods and the rod bushes, when a touch control end comes into contact with a contact point on the wire-control component, the reset spring plays a suffering action, preventing the contact points on the wire-control component from damaging, and the rod can be reset automatically upon the action of the reset spring, which is convenient to operate with a simple structure.

Since a container is provided in the operating platform, and the container is provided on one side of the wire-control component region, the container can be used for accommodating earphone wire or other members, which is convenient to operate and assuring the neatness of production line.

Since a wear-resistant bottom plate is provided at the bottom of the operating platform, the box body can be prevented from abrasion during the delivering process of production line, which affects the precision of positioning.

### BRIEF DESCRIPTION OF DRAWING

FIG. 1 is a schematic structural diagram of an example of the present invention;

FIG. 2 is a longitudinal sectional schematic structural diagram of FIG. 1;

FIG. 3 is an exploded schematic structural diagram of FIG. 1;

FIG. 4 is a schematic structural diagram of the front surface of the upper cover;

FIG. 5 is a schematic structural diagram of the back surface of the upper cover;

FIG. 6 is a schematic structural diagram of the socket, the circuit board and the signal transmitting elastic sheet;

FIG. 7 is an exploded schematic structural diagram of the bottom of the box body;

### DESCRIPTION OF REFERENCE CHARACTERS

1: operating platform; 11: box body; 12: upper cover; 13: locating hole; 14: locating pin bush; 15: earphone plug connection channel; 16: test probe connection hole; 17: container; 18: wear-resistant bottom plate; 19: connection nut; 2: wire-control component region; 3: wire slot; 4: touch control hole; 5: rod: 51: contact control end; 52: operating end; 53: rod cover plate; 54: reset spring; 6: socket; 7: circuit board; 8: rod bush; 9: installation chamber; 10: signal transmitting elastic sheet

### DETAILED DESCRIPTION OF THE INVENTION

To make the purpose, technical solution and advantages of the present invention clearer, the present invention will be further described in details with reference to the drawings and examples. It should be understood that, the specific examples described herein are only for illustrating the present invention, and not for limiting the present invention.

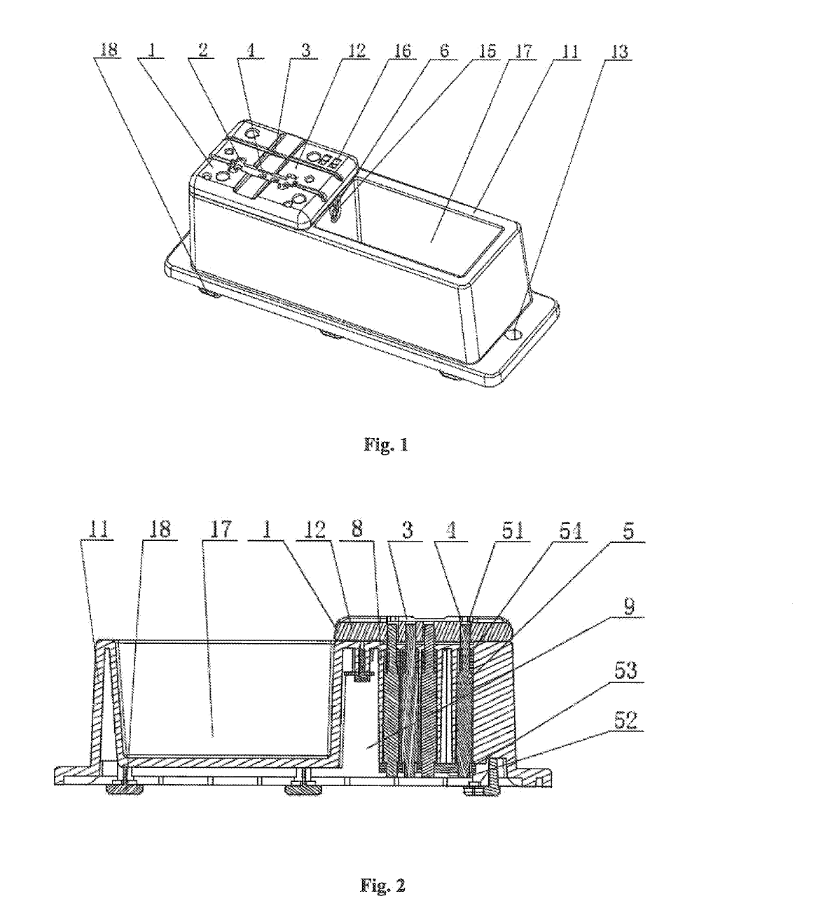

As shown in FIGS. 1, 2 and 3, a multifunctional device for assembly and test of wire-control earphone comprises an operating platform 1, and a wire-control component region 2 for disposing a wire-control component and a wire slot 3 for disposing an earphone wire are provided on the upper surface of the operating platform 1, the earphone wire is placed in the wire slot 3 to prevent other devices damaging the earphone wire, several touch control holes 4 corresponding to the contact points on the wire-control component are provided on the wire-control component region 2 of the operating platform 1, several rods 5 are slidably mounted on the operating platform 1, the rods 5 are in one-to-one correspondence with touch control holes 4, each of the rods 5 has a touch control end 51 corresponding to a touch control hole 4 and an operating end 52 protruding from the operating platform 1; a socket 6 for connection to a earphone plug is provided on the operating platform 1, the socket 6 comprises plug socket or USB socket, the socket 6 is connected to a circuit board 7, a test probe connection terminal for connecting to a test unit are provided on the circuit board 7.

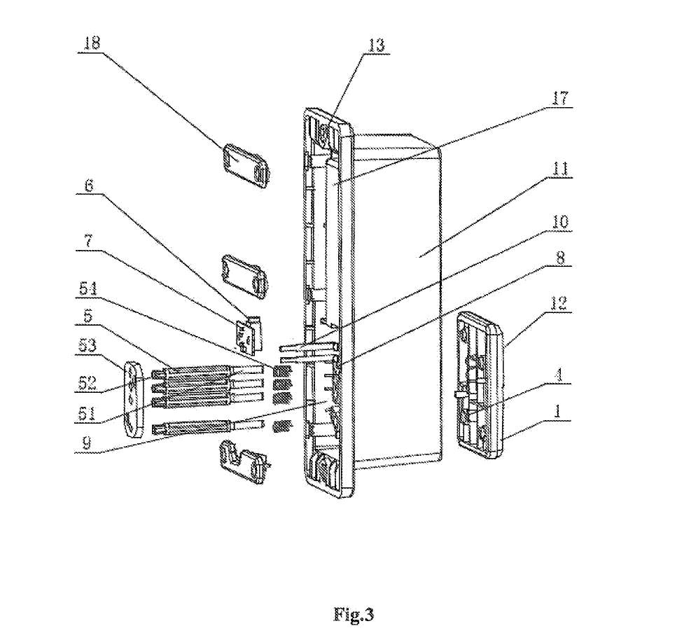

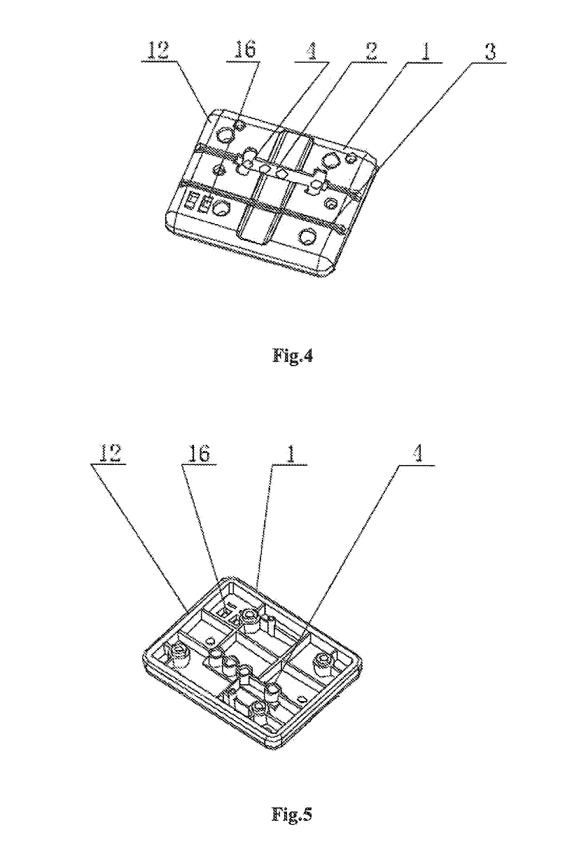

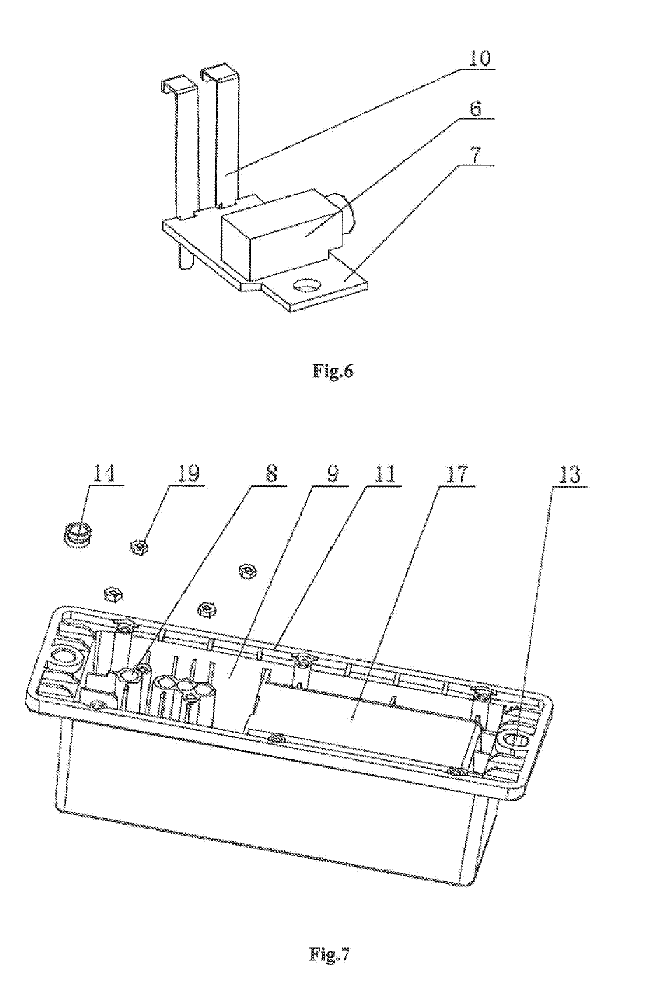

As shown in FIGS. 3-7, the operating platform 1 comprises a box body 11 and an upper cover 12 assembled fixedly as a whole, the wire-control component region 2, the wire slot 3 and the touch control hole 4 are provided on the upper cover 12, rod bushes 8 are installed in the box body 11, the rod bushes 8 and the box body 11 are configured as a whole, the rods 5 are slidably mounted in the rod bushes 8. By configuring the operating platform 1 as a replaceable structure, a suitable upper cover 12 can be selected according to the diameter of the earphone wire, the size of the wire-control component and the number of the contact points, to meeting the requirement for assembly of earphone with different diameter of wire and different size of the wire-control component, thus improving the universality of operating platform. Locating holes 13 are provided on both ends of the box body 11 for locating the box body 11 on various devices, locating pin bushes 14 are embedded in the locating holes 13, the material of the locating pin bushes 14 is stainless steel, which can be used for achieving precise location.

As shown in FIGS. 3-6, an installation chamber 9 for fixedly installing the socket 6 and the circuit board 7 is provided in the box body 11, an earphone plug connection channel 15 for connecting the earphone plug to the socket 6 is provided on the box body 11, a test probe connection hole 16 is provided on the upper cover 12, the test probe connection hole 16 corresponds to the position of the test probe connection terminal, the socket 6 and circuit board 7 are installed in the installation chamber 9 in a compact structure, thus saving the space greatly. The test probe connection terminal is connected with a signal transmitting elastic sheet 10, the end of the signal transmitting elastic sheet 10 is provided in the test probe connection hole 16, thereby transmitting a signal from the circuit board 7 to the upper cover 12 through the signal transmitting elastic sheet 10, and the probe of outer test device is only required to be connected to the test probe connection hole 16 of the upper cover 12, which is convenient to operate.

As shown in FIG. 3, a rod cover 53 for restricting the rods 5 within the rod bushes 8 is provided on the box body 11, the operating ends 52 of the rods 5 protrude from the rod cover 53, and reset springs 54 are provided between the touch control ends 51 of the rods 5 and the rod bushes 8, thus when a touch control end 51 came into contact with a contact point on the wire-control component, the reset spring 54 plays a suffering action, preventing the contact points on the wire-control component from damaging, and the rods 5 can reset automatically upon the action of reset spring 54, which is convenient to operate with a simple structure.

As shown in FIGS. 1 and 7, a container 17 for accommodating earphone wire or other members is provided in the operating platform 1, the container 17 is provided on one side of the wire-control component region 2, the container 17 is for accommodating earphone wire or other members, and the earphone wire can be wound into circles with a rather small diameter and bound and placed into the container 17, which is convenient to operate and assuring the neatness of production line, a wear-resistant bottom plate 18 is attached to the bottom of the operating platform 1 through a fastener, the fastener comprises a connection nut 19 and a screw, the connection nut 19 is embedded into the box body 11 through inject-molding, preventing the box body from abrasion during the delivering process in the production line, which affects the precision of location.

Since the multifunctional device for assembly and test of wire-control earphone according to the example of the invention comprises an operating platform 1, and a wire-control component region 2 and a wire slot 3 are provided on the upper surface of the operating platform 1, the assembly of the wire-control component can be achieved by the operating platform 1; meanwhile, since touch control holes 4 are provided in the wire-control component region 2, the touch control holes 4 are in one-to-one correspondence with rods 5, each of the rods 5 has a touch control end 51 and an operating end 52, a socket 6 is provided on the operating platform 1, the socket 6 is connected to a circuit board 7, a test probe connection terminal is provided on the circuit board 7, after an earphone plug is inserted into the socket 6, by pressing the operating end 52 of the rod 5, the touch control terminal 51 comes into contact with the contact point on the wire component, then through the test probe connection terminal on the circuit board 7, a signal is transmitted to an outer test device, thereby the test of the wire-control component is completed; therefore, the multifunctional device for assembly and test of wire-control earphone can achieve the assembly and test of the wire-control component, and achieve the universality of work device between different work stations, thus improve production efficiency greatly.

The foregoing description are merely the preferable embodiments of the present invention, are not intended to limit the protection scope of the present invention. Any modification, equivalent replacement and improvement within the spirit and principle of the present invention should fall into the protection scope of the present invention.

1. A multifunctional device for assembly and test of wire-control earphone, characterized in that, comprising an operating platform, a wire-control component region for disposing a wire-control component and a wire slot for disposing an earphone wire are provided on the upper surface of the operating platform, several touch control holes corresponding to the contact points on the wire-control component are provided in the wire-control component region of the operating platform, several rods are slidably mounted on the operating platform, the rods are in one-to-one correspondence with touch control holes, each of the rods has a touch control end corresponding to a touch control hole and an operating end protruding from the operating platform; a socket for connection to an earphone plug is provided on the operating platform, the socket is connected to a circuit hoard, a test probe connection terminals for connecting a test unit are provided on the circuit board.

2. The multifunctional device for assembly and test of wire-control earphone according to claim 1, characterized in that, the operating platform comprises a box body and an upper cover assembled fixedly as a whole, the wire-control component region, the wire slot and the touch control holes are provided on the upper cover, rod bushes are provided in the box body, the rod bushes and the box body are configured as a whole, the rods are slidably mounted in the rod bushes.

3. The multifunctional device for assembly and test of wire-control earphone according to claim 2, characterized in that, an installation chamber for fixedly installing the socket and the circuit board is provided in the box body, an earphone plug connection channel for connecting the earphone plug to the socket is provided on the box body, a test probe connection hole is provided on the upper cover, the test probe connection hole corresponds to the position of the test probe connection terminal.

4. The multifunctional device for assembly and test of wire-control earphone according to claim 3, characterized in that, the test probe connection terminal is connected with a signal transmitting elastic sheet, the end of the signal transmitting elastic sheet is provided in the test probe connection hole.

5. The multifunctional device for assembly and test of wire-control earphone according to claim 2, characterized in that a rod cover for restricting the rods within the rod bushes is provided on the box body, the operating ends of the rods protrude from the rod cover, and reset springs are provided between the touch control ends of the rods and the rod bushes.

6. The multifunctional device for assembly and test of wire-control earphone according to claim 1, characterized in that, a container for accommodating earphone wire or other members is provided in the operating platform, the container is provided on one side of the wire-control component region.

7. The multifunctional device for assembly and test of wire-control earphone according to claim 6, characterized in that a wear-resistant bottom plate is provided at the bottom of the operating platform.
